(19) United States
(12) Patent Application Publication
(10) Pub. No.: US 2026/0196020 A1
(43) Pub. Date: Jul. 9, 2026

(54) BLENDER CONDITIONAL GENERATIVE ADVERSARIAL NETWORKS

(71) Applicant: QUALCOMM Incorporated, San Diego, CA (US)

(72) Inventors: Mustafa KESKIN, San Diego, CA (US); Vikram GUPTA, San Diego, CA (US)

(21) Appl. No.: 19/014,713

(22) Filed: Jan. 9, 2025

(51) Int. Cl. G06V 10/764; G06N 3/0475; G06V 10/82

(52) U.S. Cl. CPC G06V 10/764; G06N 3/0475; G06V 10/82

(57) ABSTRACT

Certain aspects of the present disclosure provide techniques and apparatus for machine learning. In an example method, a set of exemplars corresponding to a class is accessed, and the set of exemplars is blended to generate a blended exemplar. The blended exemplar is aggregated with a noise sample to generate a noisy exemplar. An output corresponding to the class is generated based on processing the noisy exemplar using a generator neural network. The output is output.

### INTRODUCTION

Aspects of the present disclosure relate to generative machine learning.

A wide variety of machine learning model architectures have been developed to perform a variety of tasks, including generation of data such as text, images, video, audio, and the like, entity classification or detection, value or probability regression, and many others. Although recent advancements have yielded impressive generative results (e.g., images that appear highly realistic), some conventional generative artificial intelligence (AI) approaches incur substantial latency (e.g., consuming significant amounts of time to be trained and/or to generate output during runtime). Further, training initialization and convergence can be problematic without tremendous amounts of training data, and hallucinations remain a noteworthy problem.

### BRIEF SUMMARY

Certain aspects of the present disclosure provide a processor-implemented method, comprising: accessing a first set of exemplars corresponding to a first class; blending the first set of exemplars to generate a first blended exemplar; aggregating the first blended exemplar with a first noise sample to generate a first noisy exemplar; generating a first output corresponding to the first class based on processing the first noisy exemplar using a generator neural network; and outputting the first output.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for blender-based generator models, according to some aspects of the present disclosure.

FIG. 2 depicts an example workflow for blender-based generator models with dynamic scaling, according to some aspects of the present disclosure.

FIG. 3 depicts an example workflow for prompt-based blender generator models, according to some aspects of the present disclosure.

FIG. 4 depicts an example workflow for multi-label augmentation generator models, according to some aspects of the present disclosure.

FIG. 5 depicts an example workflow for multi-label prompt-based blender generator models with dynamic scales, according to some aspects of the present disclosure.

FIG. 6 is a flow diagram depicting an example method for blender generative machine learning models, according to some aspects of the present disclosure.

FIG. 7 is a flow diagram depicting an example method for generative machine learning, according to some aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved generative machine learning. Specifically, in some aspects of the present disclosure, blender-based generative models are provided to reduce runtime latency and improve output quality with reduced hallucination.

There are a wide variety of generative artificial intelligence (GenAI) architectures. One such architecture is a generative adversarial network (GAN), which comprises a pair of neural networks: a generator and a discriminator. Generally, the generator network generates output (e.g., images) based on input noise (e.g., randomly sampled noise), and the discriminator network classifies input (e.g., images) as either real (e.g., actual images from an image set) or artificial (e.g., generated by the generator network). The generator and discriminator can each be trained based on the discriminator's accuracy in identifying generated images. In some aspects, conditional GANs allow the generator network to receive a prompt (e.g., a label) indicating what the output should depict (e.g., generating images of dogs when a “dog” label is used to prompt the generator).

In some aspects of the present disclosure, a variety of improvements to conditional GAN architectures are provided. The various aspects discussed below can improve output quality, eliminate (or at least reduce) hallucinations in the output, reduce the training time and computational resources spent to reach convergence, reduce the computational expense and latency of generating output during runtime, and the like. In some aspects, a blender component can be used to blend sample images from a desired class, and this blended image data can be used to augment the random noise used as input to the generator model. By using a blended image to augment the noise, generator networks may be able to produce high quality output with reduced latency, lower computational complexity, and lower computational expense, as discussed in more detail below.

In some aspects, dynamic scales (e.g., fixed and/or learnable scales) may be used to adjust the contribution of the blended image data, enabling improved tuning of the model output (e.g., to balance generation time and expense with output novelty, where low scaling of the noise results in rapid and inexpensive outputs that may be similar to the input samples, while high scaling of the noise results in slower and more expensive output that is less similar to the sampled images). In some aspects, a prompt-based blender may be used to allow for dynamic adjustment of the blending, control different blending functions (e.g., adjusting the function and weight of the blending), and the like. In some aspects, multi-label blenders may be used to augment the generator input using images from multiple classes (with or without overlap), as discussed in more detail below.

### Example Workflow for Blender-Based Generator Models

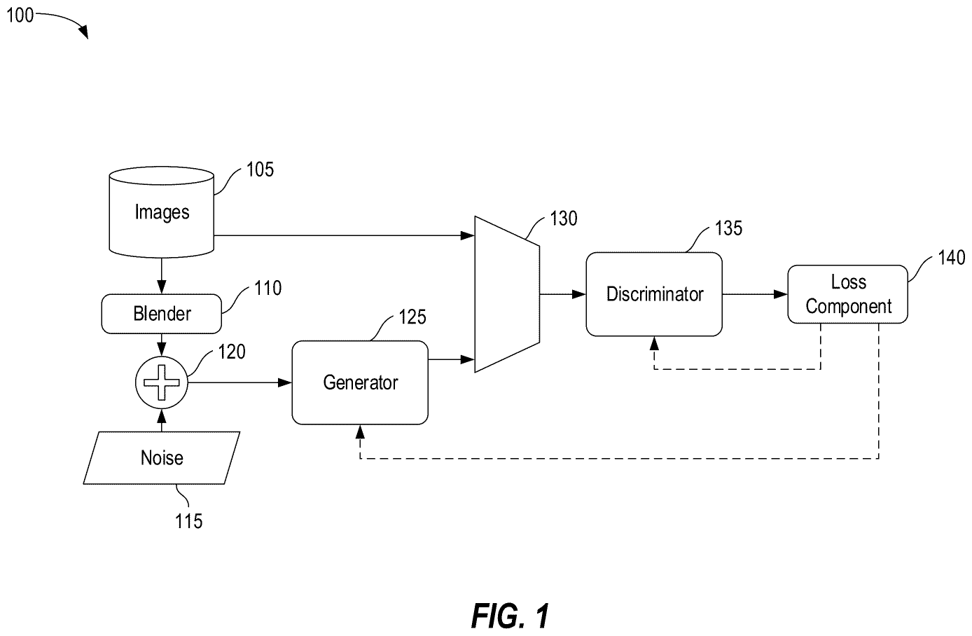

FIG. 1 depicts an example workflow 100 for blender-based generator models, according to some aspects of the present disclosure. In some aspects, the workflow 100 may be performed by a machine learning system (e.g., a computational system used to train and/or generate outputs during runtime using machine learning models).

In the illustrated workflow 100, a set of images 105 (sometimes referred to as a “set of exemplars,” such as real images depicting objects in various classes) can be accessed by a blender 110. In some aspects, the images 105 may include images belonging to any number and variety of classes, where the class generally indicates that is depicted by each image. For example, a “cat” class may comprise images of cats, while a “building” class may include images of various buildings. As illustrated, the blender 110 may access one or more images from any given class (e.g., a class selected by a user). The sampled images may then be processed (e.g., blended) to generate a blended image. In some aspects, during training, the class may be selected randomly or using any other suitable technique (e.g., to ensure that all classes are used during training).

Although the illustrated workflow 100 depicts use of a set of images 105 for conceptual clarity, in embodiments, any real exemplar or example data may be used in place of the set of images 105, depending on the particular implementation. In some embodiments, the content of the set of exemplars may vary depending on the task at hand. For example, image generation tasks may use a set of example images, audio generation tasks may use a set of example audio segments, and the like. Generally, the set of images 105 correspond to any “real” or target output for which the model(s) are being trained to create. For example, the set of exemplars may include audio data (e.g., music or voice), video data, time-domain waveforms such as sensor measurements, and the like.

In some aspects, when a class is specified, the blender 110 may access all sample images 105 (or other exemplars, such as sample videos, sample audio files, and the like, as discussed above) belonging to the selected class. In some aspects, a subset of the class images (or other exemplars) may be sampled (e.g., randomly, or based on user selection). For example, the blender 110 may randomly select five images belonging to the indicated class.

Generally, the blender 110 may perform a variety of operations to blend the input images. For example, the blender 110 may perform a variety of image (or other data) processing operations such as blending exemplars with random scales, rotations, and the like. In some aspects, the blender 110 may comprise a neural network trained to blend input exemplars. In some aspects, the blender 110 may perform operations such as randomly combining patches from the sampled images or other exemplars (e.g., selecting some patches from each image randomly to generate the blended image), generating a weighted sum of the exemplars (using random weights or defined weights), and the like. In some aspects, the blender 110 may use one or more orthogonality operations or techniques, such as Gram-Schmitt orthogonalization, to generate orthogonalized exemplars belonging to the indicated class.

In some aspects, one exemplar may be used as a “main template” or “default” exemplar for a given class, and other exemplars from the same class may be blended with this main exemplar (e.g., using smaller random scales, as compared to the “main” exemplar). In some aspects, in addition to selecting the class, the user may select the main or primary exemplar(s) to be used as input to the blender 110.

Regardless of the particular blending operations used to combine the exemplars, the blender 110 generates a single blended image or exemplar, which is provided to an aggregation component 120. As illustrated, noise 115 (referred to in some aspects as a “noise sample”) is also accessed by the aggregation component 120. In some aspects, as discussed above, the noise 115 generally corresponds to a sample of random noise (e.g., an image having random values for each pixel). In some conventional systems, the noise 115 is used as the primary (or only) input to the generator network. In the illustrated workflow 100, however, the noise 115 is processed by the aggregation component 120 to aggregate or combine the blended exemplar image (generated by the blender 110) and the noise 115.

The aggregation component 120 may perform a variety of operations to aggregate the noise 115 and blended exemplar. For example, the aggregation component 120 may sum the blended exemplar and the noise 115 (e.g., pixel-wise summation) or may average the values. Generally, the output of the aggregation component 120 may be referred to as a “noisy exemplar” (e.g., a noisy image in the case of image generation, noisy audio in the case of audio generation, and the like). As illustrated, this noisy image is used as input to the generator 125 (rather than using pure noise as input). In some aspects, as discussed above, using a noisy blended exemplar as input to the generator can significantly reduce the time to convergence during training (e.g., the time and number of training iterations used until the generator 125 produces adequate output). Similarly, the use of noisy exemplar inputs can enable the generator 125 to produce realistic output with reduced (or eliminated) hallucinations, which many other architectures suffer from. Further, in some aspects, use of noisy input exemplars can accelerate inference time (e.g., allowing output images or other data to be generated more rapidly, as compared to when random noise is used).

In some aspects, the label (used to select the image(s) 105 or other exemplars used to create the blended exemplar) is also provided as an input prompt or conditioning to the generator 125 (e.g., for conditional GANs (CGANs)). That is, the generator 125 may be tasked with generating an output image (or other data) belonging to the specified class (e.g., having the indicated label) based on the input noisy image. In some aspects, after training is complete, this generated output image may be returned or output to one or more other systems or applications (e.g., to the user that requested the generated image). That is, the remaining components (including the multiplexor 130, the discriminator 135, and the loss component 140) may be unused or discarded.

In the illustrated example, during training, the multiplexor 130 can determine whether to provide a real image 105 or other exemplar (e.g., sampled from the indicated class) or the generated image or other data (generated by the generator 125) to the discriminator 135. This selection may generally use a variety of criteria, including random selection, alternating selection, and the like. In some aspects, all generated images and all sampled images 105 may be used as input to the discriminator 135 during a given round of training (e.g., sequentially).

As discussed above, the discriminator 135 classifies the input image (or other data) as either a real image (e.g., sampled from the images 105) or a generated image (e.g., generated by the generator 125). This prediction is used by the loss component 140, along with an indication of the ground truth (e.g., an indication as to whether the multiplexor 130 selected a real image or a generated image as input for the discriminator 135), to generate a loss. As illustrated by the dotted arrows, the loss can then be used to train the generator 125 and/or discriminator 135 (e.g., to update, refine, or otherwise modify one or more parameters of the generator 125 and/or the discriminator 135).

For example, in some aspects, a shared loss may be defined using Equation 1 below, where the generator seeks to minimize the loss (e.g., updating parameters of the generator 125 in an effort to reduce the magnitude of the loss) and the discriminator seeks to maximize the loss (e.g., updating parameters of the discriminator 135 in an effort to increase the magnitude of the loss). In Equation 1 below, D(x|y) is the output of the discriminator 135 for class y if the sample is real (e.g., the probability that a real image x is real), G(z|y) is the output of the generator 125 given the noisy image z and class y, and D(G(z|y)) is the probability that the discriminator 135 classifies generated output (generated by the generator 125) as real.

$$E [ log ( D ( x \vert y ) ) ] + E [ log ( 1 - D ( G ( z \vert y ) ) ) ] \qquad ( 1 )$$

In some aspects, in addition to or instead of a single unified loss formulation, the loss component 140 may use separate losses for the generator 125 and the discriminator 135. For example, in some aspects, the generator 125 may seek to maximize log (D(G(z|y))).

As discussed above, once training is complete (e.g., after a defined number of training rounds or epochs have been performed, after a defined amount of time or computational expense has been spent training, after a desired accuracy or quality of the output of the generator 125 has been reached, and the like), the machine learning system (or another computing system) may use the images 105, blender 110, aggregation component 120, and samples of noise 115 to create input noisy images to the generator 125, prompting the generator 125 to generate realistic outputs with reduced expense and/or latency, as compared to some conventional approaches.

### Example Workflow for Blender-Based Generator Models with Dynamic Scaling

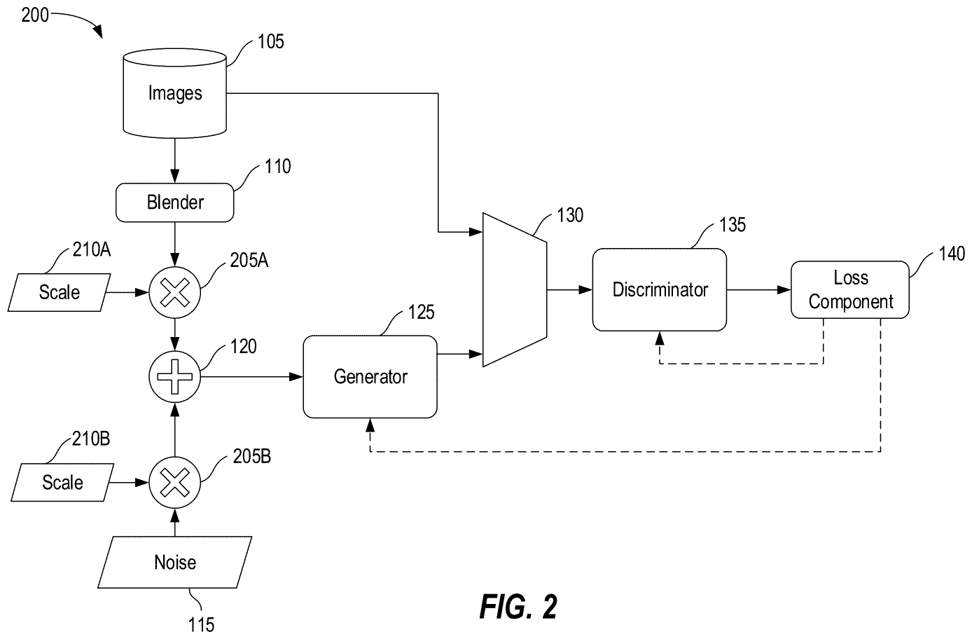

FIG. 2 depicts an example workflow 200 for blender-based generator models with dynamic scaling, according to some aspects of the present disclosure. In some aspects, the workflow 200 may be performed by a machine learning system (e.g., a computational system used to train and/or generate outputs during runtime using machine learning models), such as the machine learning system discussed above with reference to FIG. 1.

The workflow 200 shares some similarities with the workflow 100 discussed above with reference to FIG. 1. For example, in the illustrated workflow 200, the set of images 105 can be accessed by the blender 110 to generate blended images, as discussed above. That is, as discussed above, the blender 110 may sample one or more images from a given class (e.g., selected by a user or selected randomly or using other criteria) to generate a blended image for the indicated class.

As illustrated, the blended image is then provided to a scaling component 205A. The scaling component 205A scales the blended image based on an input scale 210A. The scale 210A may be a hyperparameter (e.g., specified by a user or administrator) or may be a learned value (e.g., learned during training). In some aspects, scaling the blended image may include multiplying each pixel value by a scalar scale 210A (e.g., to increase or decrease the magnitude of the blended image). This can affect the contribution of the blended image, as compared to the noise 115.

As illustrated, the scaled blended image (generated by the scaling component 205A) can then be provided to the aggregation component 120. Further, as illustrated, the noise 115 is also accessed by a scaling component 205B. The scaling component 205B scales the noise 115 based on the input scale 210B. The scale 210B may be a hyperparameter (e.g., specified by a user or administrator) or may be a learned value (e.g., learned during training). In some aspects, scaling the noise may include multiplying each pixel value by a scalar scale 210B (e.g., to increase or decrease the magnitude of the noise). This can affect the contribution of the noise 115, as compared to the blended image.

For example, if the scale 210A is higher than the scale 210B, the contribution of the blended image may be increased (relative to the noise), which may allow for more rapid output generation with less computational expense (but may result in somewhat less novelty in the generated images). In contrast, if the scale 210A is lower than the scale 210B, the contribution of the blended image is decreased, which may allow for more novel output with potentially increased computational expense.

In some aspects, the scales 210 may be selected based on user preference, or based on latency constraints or preferences. For example, for applications with strict latency constraints and/or computational constraints, the scale 210A may be increased and/or the scale 210B may be decreased to ensure that the output is generated rapidly and/or with minimal computational expense. In some aspects, the machine learning system may track the context and/or usage of the generated images to adapt the scales 210 (e.g., increasing or decreasing the contribution of the blended images based on what the generated output will be used for).

As illustrated, the scaled noise is also provided to the aggregation component 120, which aggregates or combines the scaled blended image (generated by the scaling component 205A) and the scaled noise sample (generated by the scaling component 205B), such as by performing pixel-wise summation. As discussed above, the output of the aggregation component 120 may be referred to as a “noisy image,” which is then used as input to the generator 125. In some aspects, the label (used to select the image(s) 105 used to create the blended image) is also provided as an input prompt or conditioning to the generator 125, as discussed above. In this way, the generator 125 may be tasked with generating an output image belonging to the specified class (e.g., having the indicated label) based on the input (scaled) noisy image. In some aspects, as discussed above, after training is complete, this generated output image may be returned or output to one or more other systems or applications (e.g., to the user that requested the generated image) and the remaining components (including the multiplexor 130, the discriminator 135, and the loss component 140) may be unused or discarded.

In the illustrated example, the multiplexor 130 is used to select either a real image 105 (e.g., sampled from the indicated class) or the generated image (generated by the generator 125) for input to the discriminator 135 during training. This selection may generally use a variety of criteria, including random selection, alternating selection, and the like. In some aspects, all generated images and all sampled images 105 may be used as input to the discriminator 135 during a given round of training (e.g., sequentially).

As discussed above, the discriminator 135 classifies the input image as either a real image (e.g., sampled from the images 105) or a generated image (e.g., generated by the generator 125). This prediction is used by the loss component 140, along with an indication of the ground truth (e.g., an indication as to whether the multiplexor 130 selected a real image or a generated image as input for the discriminator 135), to generate a loss. As illustrated by the dotted arrows, the loss can then be used to train the generator 125 and/or discriminator 135 (e.g., to update, refine, or otherwise modify one or more parameters of the generator 125 and/or the discriminator 135).

For example, in some aspects, a shared loss may be defined using Equation 1 above. In some aspects, the loss may be defined based at least in part on the scales 210A and 210B. For example, in some aspects, the loss may be defined based in part on the ratio between the scales 210 (e.g., a ratio

$$R = \frac{{scale}_{image}}{{scale}_{noise}} ,$$

where scale_{image} and scaleₙₒᵢₛₑ are the scales 210A and 210B, respectively, such as using Equation 2 below (where the discriminator 135 seeks to minimize the loss, and the generator 125 seeks to maximize the loss).

$$E [ R * log ( D ( x \vert y ) ) ] + E [ ( 1 - R ) * log ( 1 - D ( G ( z \vert y ) ) ) ] \qquad ( 2 )$$

In some aspects, the machine learning system may conditionally freeze training of the discriminator 135 (training only the generator 125) based on the scales 210. For example, if the scale 210A is greater than the scale 210B, the machine learning system may freeze the discriminator 135 and use only a generator loss, such as E[log(1−D(G(z|y)))], to refine the generator 125 for one or more iterations.

In some aspects, the machine learning system may modulate the loss while training the generator 125 and/or discriminator 135 based on the scales 210. For example, the loss may be defined using Equation 3 below (where the discriminator 135 seeks to minimize the loss, and the generator 125 seeks to maximize the loss).

$$E [ {scale}_{i m a g e} * log ( D ( x \vert y ) ) ] + E [ {scale}_{n o i s e} * log ( 1 - D ( G ( z \vert y ) ) ) ] \qquad ( 3 )$$

As discussed above, once training is complete (e.g., after a defined number of training rounds or epochs have been performed, after a defined amount of time or computational expense has been spent training, after a desired accuracy or quality of the output of the generator 125 has been reached, and the like), the machine learning system (or another computing system) may use the images 105, blender 110, scaling components 205, scales 210, aggregation component 120, and samples of noise 115 to create input noisy scaled images to the generator 125, prompting the generator 125 to generate realistic outputs with reduced expense and/or latency, as compared to some conventional approaches.

### Example Workflow for Prompt-Based Blender Generator Models

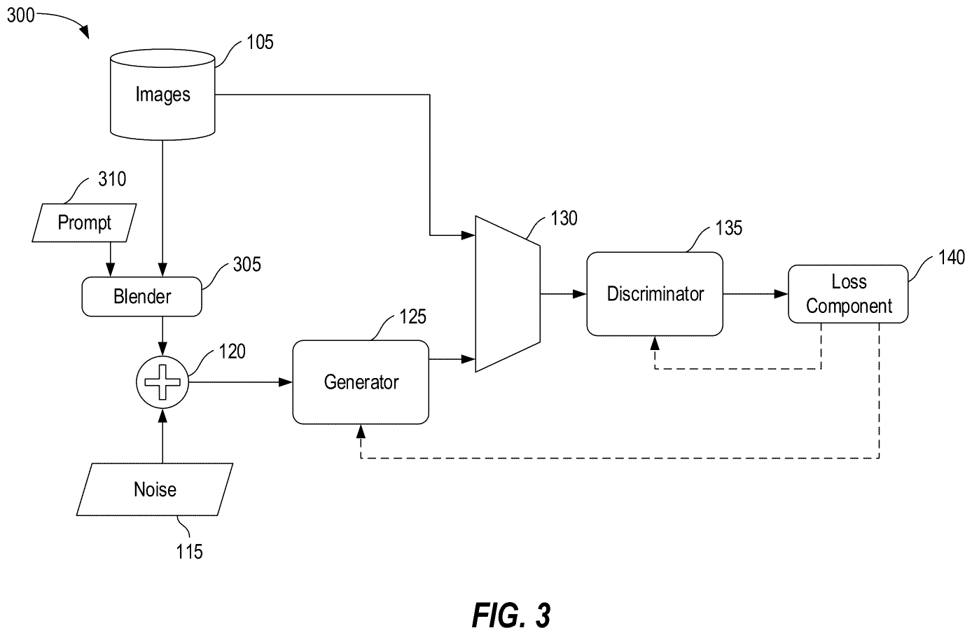

FIG. 3 depicts an example workflow 300 for prompt-based blender generator models, according to some aspects of the present disclosure. In some aspects, the workflow 300 may be performed by a machine learning system (e.g., a computational system used to train and/or generate outputs during runtime using machine learning models), such as the machine learning system discussed above with reference to FIGS. 1-2.

The workflow 300 shares some similarities with the workflow 100 discussed above with reference to FIG. 1. For example, in the illustrated workflow 300, the set of images 105 can be accessed by a blender 305 to generate blended images, as discussed above. That is, as discussed above, the blender 305 may sample one or more images from a given class (e.g., selected by a user or selected randomly or using other criteria) to generate a blended image for the indicated class.

In the illustrated example, the blender 305 may also receive a prompt 310 as input to generate the blended image. Although not depicted in the illustrated example, in some aspects the blender 305 may further receive an indication of the label or class being processed. In some aspects, the blender 305 is a trained machine learning model (e.g., a neural network) trained to mix the input images (from the given class) based in part on the prompt 310. For example, the prompt 310 may specify the function(s) used to blend the images, the weight(s) used for each function and/or image, and the like. In some aspects, the prompt 310 may be provided by a user or other requesting entity.

Generally, as discussed above, the blender 305 generates a blended image (based at least in part on the prompt), which is then provided to the aggregation component 120. As illustrated, a sample of noise 115 is also provided to the aggregation component 120. Although not included in the illustrated example, in some aspects, the prompt-based blending (e.g., using the blender 305) may be combined with the scaling concepts discussed above with reference to FIG. 2.

As discussed above, the aggregation component 120 aggregates or combines the prompt-based blended image (generated by the blender 305) and the noise 115, such as by performing pixel-wise summation. As discussed above, the output of the aggregation component 120 may be referred to as a “noisy image,” which is then used as input to the generator 125. In some aspects, the label (used to select the image(s) 105 used to create the blended image) is also provided as an input prompt or conditioning to the generator 125, as discussed above. In this way, the generator 125 may be tasked with generating an output image belonging to the specified class (e.g., having the indicated label) based on the input noisy image. In some aspects, as discussed above, after training is complete, this generated output image may be returned or output to one or more other systems or applications (e.g., to the user that requested the generated image) and the remaining components (including the multiplexor 130, the discriminator 135, and the loss component 140) may be unused or discarded.

In the illustrated example, during training, the multiplexor 130 is used to select either a real image 105 (e.g., sampled from the indicated class) or the generated image (generated by the generator 125) for input to the discriminator 135. This selection may generally use a variety of criteria, including random selection, alternating selection, and the like. In some aspects, all generated images and all sampled images 105 may be used as input to the discriminator 135 during a given round of training (e.g., sequentially).

As discussed above, the discriminator 135 classifies the input image as either a real image (e.g., sampled from the images 105) or a generated image (e.g., generated by the generator 125). This prediction is used by the loss component 140, along with an indication of the ground truth (e.g., an indication as to whether the multiplexor 130 selected a real image or a generated image as input for the discriminator 135), to generate a loss. As illustrated by the dotted arrows, the loss can then be used to train the generator 125 and/or discriminator 135 (e.g., to update, refine, or otherwise modify one or more parameters of the generator 125 and/or the discriminator 135).

Generally, the blender 305 may be a pre-trained component (e.g., trained prior to training the generator 125 and discriminator 135). Further, in the workflow 300, the loss component 140 may use a variety of loss formulations, including the losses discussed above with reference to FIGS. 1-2, to refine the generator 125 and discriminator 135.

As discussed above, once training is complete (e.g., after a defined number of training rounds or epochs have been performed, after a defined amount of time or computational expense has been spent training, after a desired accuracy or quality of the output of the generator 125 has been reached, and the like), the machine learning system (or another computing system) may use the images 105, blender 305, aggregation component 120, and samples of noise 115 to create input noisy images to the generator 125, prompting the generator 125 to generate realistic outputs with reduced expense and/or latency, as compared to some conventional approaches.

### Example Workflow for Multi-Label Augmentation Generator Models

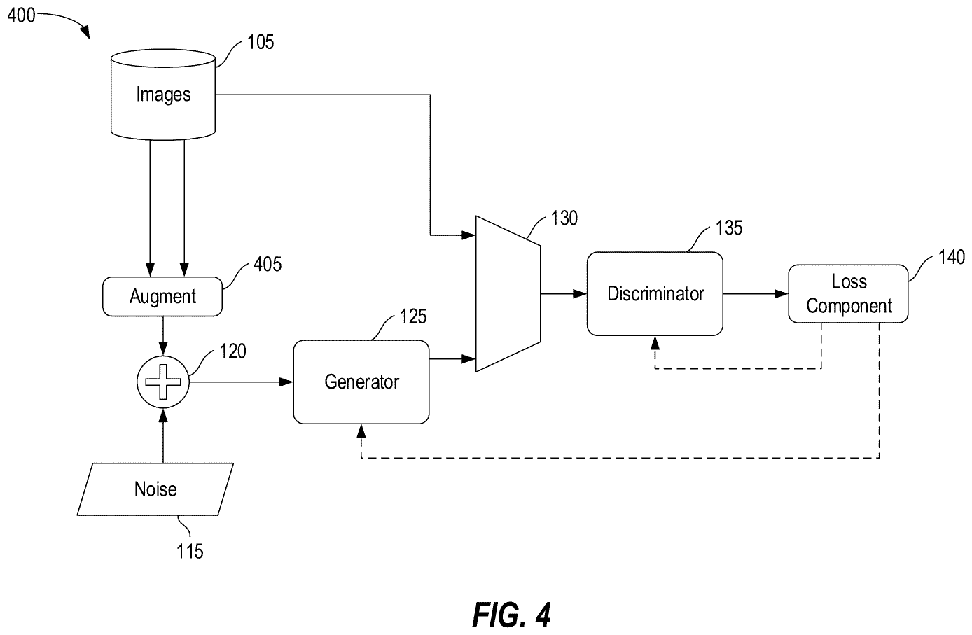

FIG. 4 depicts an example workflow 400 for multi-label augmentation generator models, according to some aspects of the present disclosure. In some aspects, the workflow 400 may be performed by a machine learning system (e.g., a computational system used to train and/or generate outputs during runtime using machine learning models), such as the machine learning system discussed above with reference to FIGS. 1-3.

The workflow 400 shares some similarities with the workflow 100 discussed above with reference to FIG. 1. For example, in the illustrated workflow 400, the set of images 105 can be accessed by an augmentation component 405 to generate blended or augmented images, as discussed in more detail below. That is, rather than using a blender to sample one or more images from a given class (e.g., selected by a user or selected randomly or using other criteria) to generate a blended image for the indicated class, the augmentation component 405 may sample image(s) from multiple classes in order to generate a blended image corresponding to multiple classes.

In some aspects, the augmentation component 405 acts as both a blender (e.g., the blender 110 of FIGS. 1-2 and/or the blender 305 of FIG. 3) as well as an augmenter. For example, in some aspects, for each selected or indicated class, the augmentation component 405 may generate a corresponding blended image based on sampling one or more images 105 from the indicated class. The augmentation component 405 may then combine or aggregate these blended images to generate an overall blended and/or augmented image reflecting the multiple classes. In some aspects, the augmentation component 405 may produce a blended image where the various classes are instanced separately without overlap.

For example, based on various object recognition techniques, the augmentation component 405 may determine the position of the object(s) of interest in each blended image (e.g., the position of the dog in a blended image for the “dog” class and the position of the cat in a blended image for the “cat” class). The augmentation component 405 may offset one or both of the blended images if called for, allowing the blended images to be combined such that the objects from each selected class (e.g., the dog and the cat) are both visible separately (rather than blended together) in the final blended or augmented image. Generally, the augmentation component 405 may be able to combine two or more classes into a single blended image.

Although not depicted in the illustrated example, in some aspects the augmentation component 405 (or another component) may further receive a prompt (e.g., for the prompt-based blending discussed above with reference to FIG. 3). Similarly, although not included in the illustrated example, in some aspects, the multi-class augmentation blending (e.g., using the augmentation component 405) may be combined with the scaling concepts discussed above with reference to FIG. 2.

As discussed above, the aggregation component 120 aggregates or combines the augmented (e.g., multi-class) blended image (generated by the augmentation component 405) and the noise 115, such as by performing pixel-wise summation. As discussed above, the output of the aggregation component 120 may be referred to as a “noisy image,” which is then used as input to the generator 125. In some aspects, the label(s) (used to select the image(s) 105 used by the augmentation component 405) are also provided as an input prompt or conditioning to the generator 125, as discussed above. In this way, the generator 125 may be tasked with generating an output image belonging to or depicting all of the specified classes (e.g., having the indicated labels) based on the input noisy image. In some aspects, as discussed above, after training is complete, this generated output image may be returned or output to one or more other systems or applications (e.g., to the user that requested the generated image) and the remaining components (including the multiplexor 130, the discriminator 135, and the loss component 140) may be unused or discarded.

In the illustrated example, during training, the multiplexor 130 is used to select either a real image 105 (e.g., sampled from the indicated class) or the generated image (generated by the generator 125) for input to the discriminator 135. This selection may generally use a variety of criteria, including random selection, alternating selection, and the like. In some aspects, all generated images and all sampled images 105 may be used as input to the discriminator 135 during a given round of training (e.g., sequentially).

As discussed above, the discriminator 135 classifies the input image as either a real image (e.g., sampled from the images 105) or a generated image (e.g., generated by the generator 125). This prediction is used by the loss component 140, along with an indication of the ground truth (e.g., an indication as to whether the multiplexor 130 selected a real image or a generated image as input for the discriminator 135), to generate a loss. As illustrated by the dotted arrows, the loss can then be used to train the generator 125 and/or discriminator 135 (e.g., to update, refine, or otherwise modify one or more parameters of the generator 125 and/or the discriminator 135).

Generally, in the workflow 400, the loss component 140 may use a variety of loss formulations, including the losses discussed above with reference to FIGS. 1-2, to refine the generator 125 and discriminator 135.

As discussed above, once training is complete (e.g., after a defined number of training rounds or epochs have been performed, after a defined amount of time or computational expense has been spent training, after a desired accuracy or quality of the output of the generator 125 has been reached, and the like), the machine learning system (or another computing system) may use the images 105, augmentation component 405, aggregation component 120, and samples of noise 115 to create input noisy images to the generator 125, prompting the generator 125 to generate realistic outputs with reduced expense and/or latency, as compared to some conventional approaches.

### Example Workflow for Multi-Label Prompt-Based Blender Generator Models with Dynamic Scales

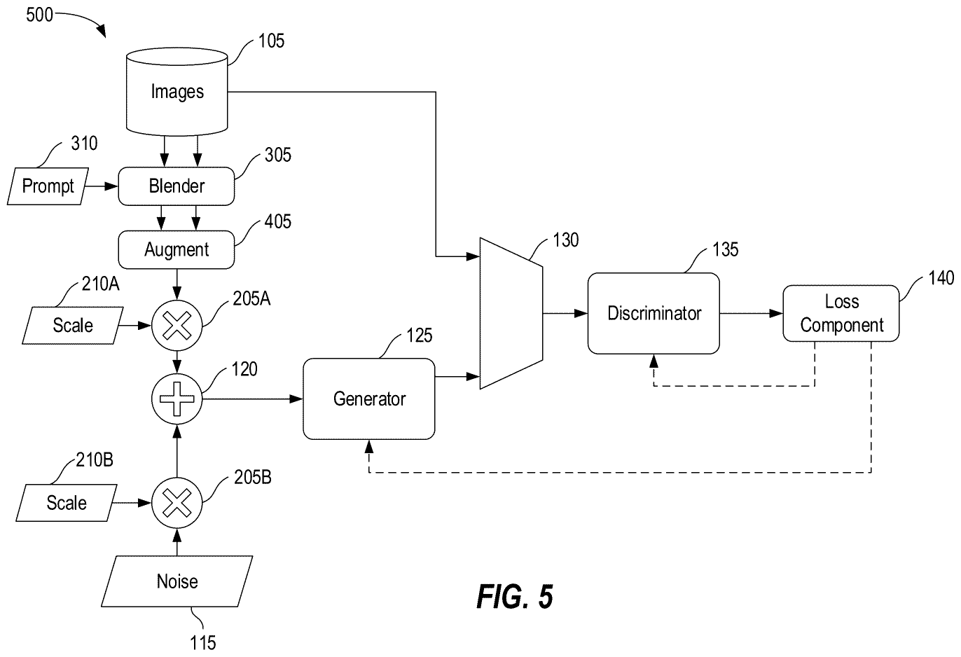

FIG. 5 depicts an example workflow 500 for multi-label prompt-based blender generator models with dynamic scales, according to some aspects of the present disclosure. In some aspects, the workflow 500 may be performed by a machine learning system (e.g., a computational system used to train and/or generate outputs during runtime using machine learning models), such as the machine learning system discussed above with reference to FIGS. 1-4.

The workflow 500 shares some similarities with the workflows 100, 200, 300, and 400 discussed above with reference to FIGS. 1-4. Specifically, the workflow 500 can use non-prompted blending (discussed above with reference to FIG. 1), prompt-based blending (discussed above with reference to FIG. 3), multi-class augmentation (discussed above with reference to FIG. 4), and/or noise and image scaling (discussed above with reference to FIG. 2). That is, as illustrated in the workflow 500, any combination of the various architectures and components discussed above may be combined to form a single architecture for image generation.

For example, in the illustrated workflow 500, the set of images 105 can be accessed by a blender 305 to generate blended images based on a prompt 310. Alternatively, the set of images 105 may be processed to generate blended images using a non-prompted blender, such as the blender 110 of FIG. 1. Generally, as discussed above, the blender 305 may generate a respective blended image for each respective class that is being augmented or combined to generate the output image.

These blended images are then provided to the augmentation component 405 to generate blended or augmented images. That is, as discussed above, the augmentation component 405 may combine the blended image for each selected class to generate an overall blended image. The blended image is then provided to the scaling component 205A, which scales the blended image based on the scale 210A, as discussed above. The scaled blended image is then provided to the aggregation component 120. Further as illustrated, the sample of noise 115 can also be scaled by a scale 210B using the scaling component 205B. The scaled noise sample can then be provided to the aggregation component 120.

As discussed above, the aggregation component 120 aggregates or combines the augmented, (e.g., multi-class) scaled, and blended image and the scaled noise, such as by performing pixel-wise summation. As discussed above, the output of the aggregation component 120 may be referred to as a “noisy image,” which is then used as input to the generator 125. In some aspects, the label(s) (used to select the image(s) classes) are also provided as an input prompt or conditioning to the generator 125, as discussed above. In this way, the generator 125 may be tasked with generating an output image belonging to or depicting all of the specified classes (e.g., having the indicated labels) based on the input noisy image. In some aspects, as discussed above, after training is complete, this generated output image may be returned or output to one or more other systems or applications (e.g., to the user that requested the generated image) and the remaining components (including the multiplexor 130, the discriminator 135, and the loss component 140) may be unused or discarded.

In the illustrated example, during training, the multiplexor 130 is used to select either a real image 105 (e.g., sampled from the indicated class) or the generated image (generated by the generator 125) for input to the discriminator 135. This selection may generally use a variety of criteria, including random selection, alternating selection, and the like. In some aspects, all generated images and all sampled images 105 may be used as input to the discriminator 135 during a given round of training (e.g., sequentially).

As discussed above, the discriminator 135 classifies the input image as either a real image (e.g., sampled from the images 105) or a generated image (e.g., generated by the generator 125). This prediction is used by the loss component 140, along with an indication of the ground truth (e.g., an indication as to whether the multiplexor 130 selected a real image or a generated image as input for the discriminator 135), to generate a loss. As illustrated by the dotted arrows, the loss can then be used to train the generator 125 and/or discriminator 135 (e.g., to update, refine, or otherwise modify one or more parameters of the generator 125 and/or the discriminator 135).

Generally, in the workflow 500, the loss component 140 may use a variety of loss formulations, including the losses discussed above with reference to FIGS. 1-2, to refine the generator 125 and discriminator 135.

As discussed above, once training is complete (e.g., after a defined number of training rounds or epochs have been performed, after a defined amount of time or computational expense has been spent training, after a desired accuracy or quality of the output of the generator 125 has been reached, and the like), the machine learning system (or another computing system) may use the images 105, blender 305, augmentation component 405, scaling components 205, aggregation component 120, and samples of noise 115 to create input noisy images to the generator 125, prompting the generator 125 to generate realistic outputs with reduced expense and/or latency, as compared to some conventional approaches.

### Example Method for Blender Generative Machine Learning Models

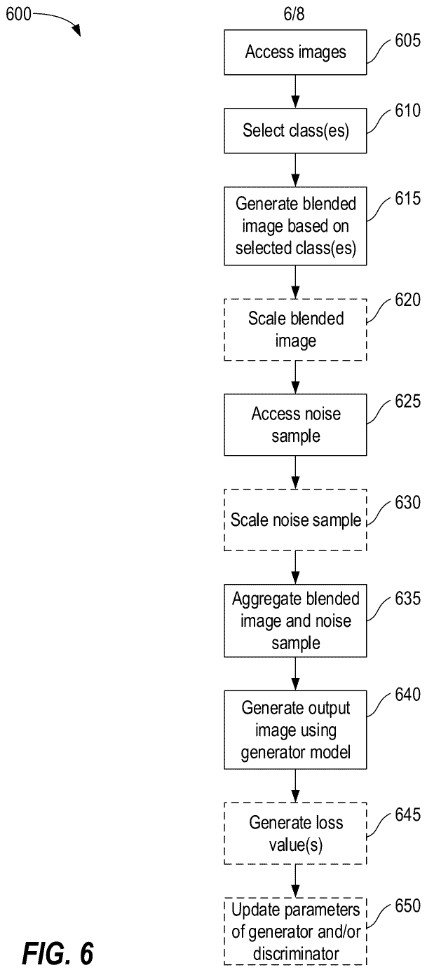

FIG. 6 is a flow diagram depicting an example method 600 for blender generative machine learning models, according to some aspects of the present disclosure. In some aspects, the method 600 may be performed by a machine learning system (e.g., a computational system used to train and/or generate outputs during runtime using machine learning models), such as the machine learning system discussed above with reference to FIGS. 1-5.

At block 605, the machine learning system accesses a set of images to augment the training and/or inference process of a generative model (e.g., a conditional GAN), as discussed above. Generally, “accessing” data may include receiving, retrieving, obtaining, colleting, generating, gathering, requesting, or otherwise gaining access to the data. For example, the machine learning system may access the images by gaining access to a repository of images, by being provided the images by a requesting entity (e.g., a user, and the like. The images (which may correspond to the images 105 of FIGS. 1-5) generally comprise a set of real images belonging to one or more classes (e.g., having one or more labels), such as based on what each image depicts.

As discussed above, although the illustrated example depicts accessing a set of images, the method 600 may generally use any set of exemplar data (e.g., audio, video, images, sensor data, and the like) to augment the training and/or inference process, depending on the particular desired output of the generative model.

At block 610, the machine learning system selects one or more class(es), from the set of classes reflected in the accessed images (or other exemplars). In some aspects, the machine learning system selects the class(es) based on an indication or instruction from a requesting entity (e.g., from the user or from another application that is requesting an image be generated). In some aspects, as discussed above, the machine learning system selects a single class. In some aspects, as discussed above, the machine learning system may select multiple classes (e.g., in multi-label augmentation approaches).

At block 615, the machine learning system generates a blended image based on the selected class(es). Generally, the particular techniques used to generate the blended image may vary depending on the particular implementation. For example, in some aspects, the machine learning system may select all or a subset of the images, from the set of images accessed at block 605, that belong to a selected class, and may blend these images using various techniques. In some aspects, the machine learning system may sample the images randomly (from within the class). In some aspects, the machine learning system may sample the images based at least in part on a prompt (e.g., selecting images from the “dog” class based on a prompt such as “jumping dog”).

In some aspects, the machine learning system blends the sampled images randomly. In some aspects, the machine learning system uses one or more “main” or “primary” images from the class, and blends in the other sampled images with lower weights. In some aspects, the machine learning system blends the images based at least in part on an input prompt (e.g., indicating blending operations or weights to apply).

In some aspects, if multiple classes were selected, the machine learning system may generate a respective blended image for each respective class, as discussed above. The machine learning system may then blend or augment the blended images, such as by concatenating the blended images or otherwise offsetting and/or combining the blended images such that the object(s) of interest for each class are non-overlapping and represented separately in the final blended image.

At block 620, the machine learning system optionally scales the blended image (e.g., based on a scale value, such as the scale 210A of FIG. 2). In some aspects, as discussed above, scaling the blended image may comprise increasing or decreasing the magnitude of the image pixels, such as by multiplying each pixel value by a scalar value. In some aspects, as discussed above, the image scale may be a learned parameter (e.g., learned while training the model), may be a fixed hyperparameter (e.g., configured based on the desired deployment of the model and/or use case for the generated images), and/or may be a user-configurable hyperparameter.

At block 625, the machine learning system accesses (e.g., generates) a random noise sample (e.g., the noise 115 of FIGS. 1-5). As discussed above, the noise sample may generally correspond to an image depicting random noise (e.g., with random values for each pixel).

At block 630, the machine learning system optionally scales the noise sample (e.g., based on a scale value, such as the scale 210B of FIG. 2). In some aspects, as discussed above, scaling the noise may comprise increasing or decreasing the magnitude of the image pixels, such as by multiplying each pixel value by a scalar value. In some aspects, as discussed above, the noise scale may be a learned parameter (e.g., learned while training the model), may be a fixed hyperparameter (e.g., configured based on the desired deployment of the model and/or use case for the generated images), and/or may be a user-configurable hyperparameter.

At block 635, the machine learning system aggregates the (potentially scaled) blended image (generated at block 615) and the (potentially scaled) noise sample (generated at block 625) to generate a noisy image (e.g., using the aggregation component 120 of FIGS. 1-5). Generally, the particular operations used to merge the noise and the blended image may vary depending on the particular implementation. For example, as discussed above, the machine learning system may compute the pixel-wise sum or average of the blended image and the noise.

At block 640, the machine learning system generates an output image using a generator model (e.g., the generator 125 of FIGS. 1-5). That is, the machine learning system may process the noisy image (generated at block 635) using the generator network (along with an indication of the desired class(es), in some aspects) to prompt the generator to generate an output image belonging to the indicated class(es) (and based on the input noisy image).

As discussed above, if the method 600 is being performed during runtime (e.g., after training), the method 600 may terminate after block 640, and the output image may be provided to the requesting entity or relevant downstream entity (e.g., the user or application that requested generation of the image). If the method 600 is being performed during training, the method 600 may continue to block 645.

At block 645, the machine learning system optionally generates one or more loss values based on the generated output image. For example, as discussed above with reference to FIGS. 1-2, the machine learning system may generate one or more loss terms to refine the generator, the discriminator, or both based on the output of the discriminator, the scales used to scale the blended images and noise samples, and the like.

At block 650, the machine learning system updates one or more parameters of the generator and/or discriminator using the generated loss(es) (e.g., using backpropagation), as discussed above. In this way, the machine learning system can train the generator to generate improved output images with reduced computational expense and latency, as compared to some conventional approaches.

### Example Method for Generative Machine Learning

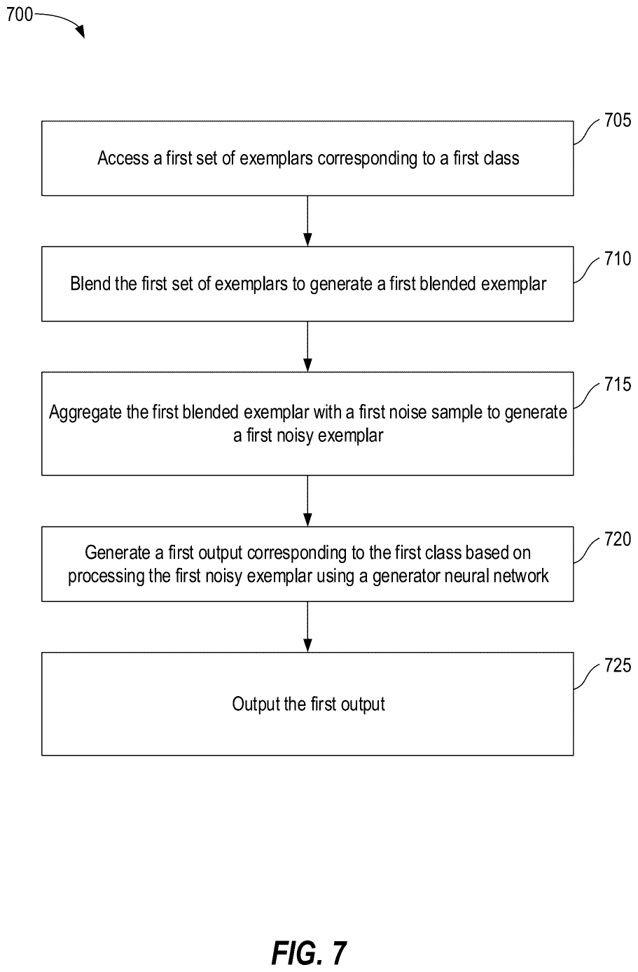

FIG. 7 is a flow diagram depicting an example method 700 for generative machine learning, according to some aspects of the present disclosure. In some aspects, the method 700 may be performed by a machine learning system (e.g., a computational system used to train and/or generate outputs during runtime using machine learning models), such as the machine learning system discussed above with reference to FIGS. 1-6.

At block 705, a first set of exemplars (e.g., the images 105 of FIGS. 1-5) corresponding to a first class is accessed.

At block 710, the first set of exemplars is blended (e.g., to create a blended image of FIGS. 1-5).

At block 715, the first blended exemplar is aggregated with a first noise sample (e.g., the noise 115 of FIGS. 1-5) to generate a first noisy exemplar.

At block 720, a first output corresponding to the first class is generated (e.g., using the generator 125 of FIGS. 1-5) based on processing the first noisy exemplar using a generator neural network.

At block 725, the first output is output.

In some aspects, aggregating the first blended exemplar with the first noise sample comprises scaling at least one of the first blended exemplar or the first noise sample based on one or more scale values.

In some aspects, the one or more scale values comprise hyperparameters defined by a requesting entity for the first output.

In some aspects, the one or more scale values comprise trained parameters having one or more values learned during training of the generator neural network.

In some aspects, the method 700 further includes further training the generator neural network and a discriminator neural network based at least in part on the one or more scale values.

In some aspects, training the generator neural network and the discriminator neural network comprises at least one of: (i) training at least one of the generator neural network or the discriminator neural network based on a ratio between first and second scale values of the one or more scale values, (ii) conditionally freezing training of the discriminator neural network based on comparing the first and second scale values, or (iii) modulating a loss while training at least one of the generator neural network or the discriminator neural network based on the first and second scale values.

In some aspects, wherein blending the first set of exemplars comprises at least one of: (i) combining patches from at least two exemplars of the first set of exemplars to form the first blended exemplar, (ii) generating a weighted sum of the first set of exemplars to generate the first blended exemplar, (iii) using one or more orthogonality operations to generate the first blended exemplar based on the first set of exemplars, or (iv) data processing at least one exemplar of the first set of exemplars to generate the first blended exemplar.

In some aspects, blending the first set of exemplars comprises processing the first set of exemplars using a blending neural network.

In some aspects, blending the first set of exemplars further comprises evaluating a prompt indicating one or more blending functions to generate the first blended exemplar using the blending neural network.

In some aspects, the method 700 further includes accessing a second set of exemplars corresponding to a second class, blending the second set of exemplars to generate a second blended exemplar, combine the first blended exemplar and the second blended exemplar to generate an augmented exemplar, aggregating the augmented exemplar with a second noise sample to generate a second noisy exemplar, and generating a second output corresponding to the first and second classes based on processing the second noisy exemplar using the generator neural network.

### Example Processing System for Generative Machine Learning

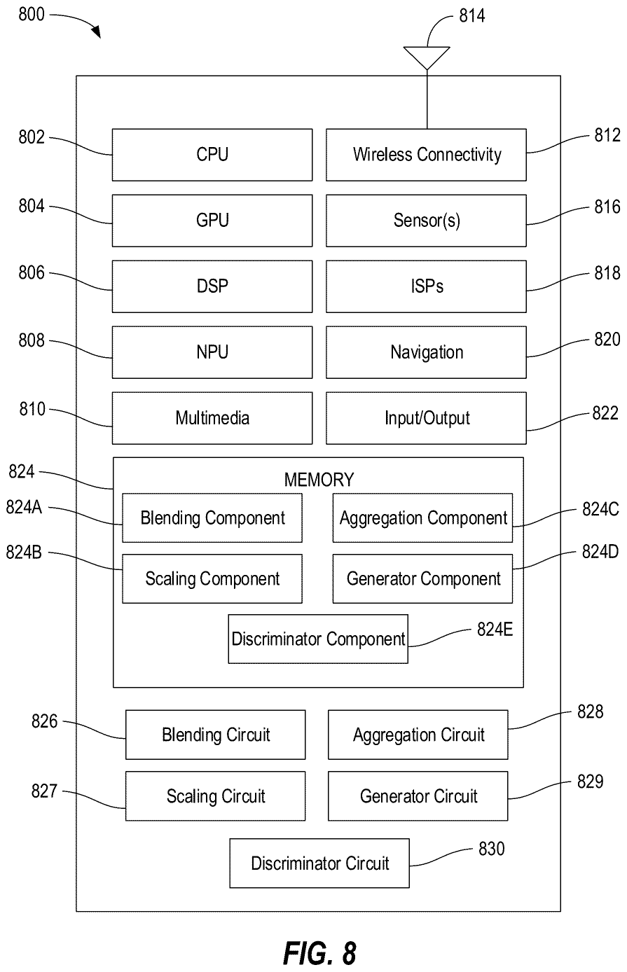

FIG. 8 depicts an example processing system 800 configured to perform various aspects of the present disclosure, including, for example, the techniques and methods described with respect to FIGS. 1-7. In some aspects, the processing system 800 may correspond to a machine learning system. For example, the processing system 800 may correspond to the machine learning system discussed above with reference to FIGS. 1-7. Although depicted as a single system for conceptual clarity, in some aspects, as discussed above, the components described below with respect to the processing system 800 may be distributed across any number of devices or systems.

The processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., a partition of a memory 824).

The processing system 800 also includes additional processing components tailored to specific functions, such as a graphics processing unit (GPU) 804, a digital signal processor (DSP) 806, a neural processing unit (NPU) 808, a multimedia component 810 (e.g., a multimedia processing unit), and a wireless connectivity component 812.

An NPU, such as the NPU 808, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 808 is a part of one or more of the CPU 802, the GPU 804, and/or the DSP 806.

In some examples, the wireless connectivity component 812 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 812 is further coupled to one or more antennas 814.

The processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The processing system 800 also includes a memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes a blending component 824A, a scaling component 824B, an aggregation component 824C, a generator component 824D, and a discriminator component 824E. Although not depicted in the illustrated example, the memory 824 may also include other components, such as an inferencing or generation component to manage the generation of output data using generative machine learning models, a training component used to train or update the generative machine learning model(s), and the like. Though depicted as discrete components for conceptual clarity in FIG. 8, the illustrated components (and others not depicted) may be collectively or individually implemented in various aspects.

Further, although not depicted in the illustrated example, the memory 824 may also include various data, such as a set of model parameters (e.g., parameters of one or more generative machine learning models), training data, sample images, and the like.

The processing system 800 further comprises a blending circuit 826, a scaling circuit 827, an aggregation circuit 828, a generator circuit 829, and a discriminator circuit 830. The depicted circuits, and others not depicted (such as an inferencing circuit), may be configured to perform various aspects of the techniques described herein.

The blending component 824A and/or the blending circuit 826 (which may correspond to the blender 110 of FIGS. 1-2, the blender 305 of FIGS. 3 and/or 5, and/or the augmentation component 405 of FIGS. 4-5) may be used to blend exemplars (e.g., images) from a given class to generate a representative blended exemplar, as discussed above. For example, the blending component 824A and/or the blending circuit 826 may use various techniques such as orthogonalization, random sampling of example patches, and the like to blend the exemplars.

The scaling component 824B and/or the scaling circuit 827 (which may correspond to the scaling components 205 of FIGS. 2 and/or 5) may be used to scale blended exemplars and/or noise prior to aggregation, as discussed above. For example, the scaling component 824B and/or the scaling circuit 827 may scale the blended exemplars and/or noise to control the computational expense and/or latency of the data generation process.

The aggregation component 824C and/or the aggregation circuit 828 (which may correspond to the aggregation component 120 of FIGS. 1-5) may be used to aggregate blended exemplars and noise samples, as discussed above. For example, the aggregation component 824C and/or the aggregation circuit 828 may sum the pixel values in (potentially scaled) blended images with those in the (potentially scaled) noise sample.

The generator component 824D and/or the generator circuit 829 (which may correspond to the generator 125 of FIGS. 1-5) may be used to generate output data (e.g., images, audio, and the like) based on input noisy exemplars, as discussed above. For example, the generator component 824D and/or the generator circuit 829 may comprise a conditional generator neural network (e.g., as part of a conditional GAN architecture).

The discriminator component 824E and/or the discriminator circuit 830 (which may correspond to the discriminator 135 of FIGS. 1-5) may be used to classify input exemplars as either real (e.g., from a set of real sample images) or artificial (e.g., generated by the generator component 824D and/or generator circuit 829), as discussed above. For example, the discriminator component 824E and/or the discriminator circuit 830 may comprise a discriminator neural network (e.g., as part of a conditional GAN architecture).

Though depicted as separate components and circuits for clarity in FIG. 8, the blending circuit 826, the scaling circuit 827, the aggregation circuit 828, the generator circuit 829, and the discriminator circuit 830 may collectively or individually be implemented in other processing devices of the processing system 800, such as within the CPU 802, the GPU 804, the DSP 806, the NPU 808, and the like.

Generally, the processing system 800 and/or components thereof may be configured to perform the methods described herein.

Notably, in other aspects, aspects of the processing system 800 may be omitted, such as where the processing system 800 is a server computer or the like. For example, the multimedia component 810, the wireless connectivity component 812, the sensor processing units 816, the ISPs 818, and/or the navigation processor 820 may be omitted in other aspects. Further, aspects of the processing system 800 maybe distributed between multiple devices.

### EXAMPLE CLAUSES

Implementation examples are described in the following numbered clauses:

Clause 1: A method, comprising: accessing a first set of exemplars corresponding to a first class; blending the first set of exemplars to generate a first blended exemplar; aggregating the first blended exemplar with a first noise sample to generate a first noisy exemplar; generating a first output corresponding to the first class based on processing the first noisy exemplar using a generator neural network; and outputting the first output.

Clause 2: A method according to Clause 1, wherein aggregating the first blended exemplar with the first noise sample comprises scaling at least one of the first blended exemplar or the first noise sample based on one or more scale values.

Clause 3: A method according to Clause 2, wherein the one or more scale values comprise hyperparameters defined by a requesting entity for the first output.

Clause 4: A method according to Clause 2, wherein the one or more scale values comprise trained parameters having one or more values learned during training of the generator neural network.

Clause 5: A method according to any of Clauses 2-4, further comprising training the generator neural network and a discriminator neural network based at least in part on the one or more scale values.

Clause 6: A method according to Clause 5, wherein training the generator neural network and the discriminator neural network comprises at least one of: (i) training at least one of the generator neural network or the discriminator neural network based on a ratio between first and second scale values of the one or more scale values, (ii) conditionally freezing training of the discriminator neural network based on comparing the first and second scale values, or (iii) modulating a loss while training at least one of the generator neural network or the discriminator neural network based on the first and second scale values.

Clause 7: A method according to any of Clauses 1-6, wherein blending the first set of exemplars comprises at least one of: (i) combining patches from at least two exemplars of the first set of exemplars to form the first blended exemplar, (ii) generating a weighted sum of the first set of exemplars to generate the first blended exemplar, (iii) using one or more orthogonality operations to generate the first blended exemplar based on the first set of exemplars, or (iv) data processing at least one exemplar of the first set of exemplars to generate the first blended exemplar.

Clause 8: A method according to Clause 1-7, wherein blending the first set of exemplars comprises processing the first set of exemplars using a blending neural network.

Clause 9: A method according to Clause 8, wherein blending the first set of exemplars further comprises evaluating a prompt indicating one or more blending functions to generate the first blended exemplar using the blending neural network.

Clause 10: A method according to any of Clauses 1-9, further comprising: accessing a second set of exemplars corresponding to a second class; blending the second set of exemplars to generate a second blended exemplar; combining the first blended exemplar and the second blended exemplar to generate an augmented exemplar; and generating a second output corresponding to the first and second classes based on the augmented exemplar and using the generator neural network.

Clause 11: A method according to Clause 9, further comprising: aggregating the augmented exemplar with a second noise sample to generate a second noisy exemplar, wherein generating the second output corresponding to the first and second classes comprises processing the second noisy exemplar using the generator neural network.

Clause 12: A method according to any of Clauses 1-10, wherein the generator neural network is part of a conditional generative adversarial network (GAN).

Clause 13: A processing system comprising: one or more memories comprising processor-executable instructions; and one or more processors coupled to the one or more memories and configured to execute the processor-executable instructions and cause the processing system to perform a method in accordance with any of Clauses 1-12.

Clause 14: A processing system comprising means for performing a method in accordance with any of Clauses 1-12.

Clause 15: A non-transitory computer-readable medium comprising computer-executable instructions that, when executed by one or more processors of a processing system, cause the processing system to perform a method in accordance with any of Clauses 1-12.

Clause 16: A computer program product embodied on a computer-readable storage medium comprising code for performing a method in accordance with any of Clauses 1-12.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
one or more memories comprising processor-executable instructions; and
one or more processors coupled to the one or more memories and configured to execute the processor-executable instructions and cause the processing system to:
access a first set of exemplars corresponding to a first class;
blend the first set of exemplars to generate a first blended exemplar;
aggregate the first blended exemplar with a first noise sample to generate a first noisy exemplar;
generate a first output corresponding to the first class based on processing the first noisy exemplar using a generator neural network; and
output the first output.

2. The processing system of claim 1, wherein, to aggregate the first blended exemplar with the first noise sample, the one or more processors are configured to execute the processor-executable instructions and cause the processing system to scale at least one of the first blended exemplar or the first noise sample based on one or more scale values.

3. The processing system of claim 2, wherein the one or more scale values comprise hyperparameters defined by a requesting entity for the first output.

4. The processing system of claim 2, wherein the one or more scale values comprise trained parameters having one or more values learned during training of the generator neural network.

5. The processing system of claim 2, wherein the one or more processors are further configured to execute the processor-executable instructions and cause the processing system to train the generator neural network and a discriminator neural network based at least in part on the one or more scale values.

6. The processing system of claim 5, wherein, to train the generator neural network and the discriminator neural network, the one or more processors are configured to execute the processor-executable instructions and cause the processing system to:
(i) train at least one of the generator neural network or the discriminator neural network based on a ratio between first and second scale values of the one or more scale values,
(ii) conditionally freeze training of the discriminator neural network based on comparing the first and second scale values, or
(iii) modulate a loss while training at least one of the generator neural network or the discriminator neural network based on the first and second scale values.

7. The processing system of claim 1, wherein, to blend the first set of exemplars, the one or more processors are configured to execute the processor-executable instructions and cause the processing system to:
(i) combine patches from at least two exemplars of the first set of exemplars to form the first blended exemplar,
(ii) generate a weighted sum of the first set of exemplars to generate the first blended exemplar,
(iii) use one or more orthogonality operations to generate the first blended exemplar based on the first set of exemplars, or
(iv) data process at least one exemplar of the first set of exemplars to generate the first blended exemplar.

8. The processing system of claim 1, wherein, to blend the first set of exemplars, the one or more processors are configured to execute the processor-executable instructions and cause the processing system to process the first set of exemplars using a blending neural network.

9. The processing system of claim 8, wherein, to blend the first set of exemplars, the one or more processors are further configured to execute the processor-executable instructions and cause the processing system to evaluate a prompt indicating one or more blending functions to generate the first blended exemplar using the blending neural network.

10. The processing system of claim 1, wherein the one or more processors are further configured to execute the processor-executable instructions and cause the processing system to:
access a second set of exemplars corresponding to a second class;
blend the second set of exemplars to generate a second blended exemplar;
combine the first blended exemplar and the second blended exemplar to generate an augmented exemplar; and
generate a second output corresponding to the first and second classes based on the augmented exemplar and using the generator neural network.

11. The processing system of claim 10, wherein the one or more processors are further configured to execute the processor-executable instructions and cause the processing system to aggregate the augmented exemplar with a second noise sample to generate a second noisy exemplar, wherein, to generate the second output, the one or more processors are further configured to execute the processor-executable instructions and cause the processing system to process the second noisy exemplar using the generative machine learning model.

12. A processor-implemented method of machine learning, comprising:
accessing a first set of exemplars corresponding to a first class;
blending the first set of exemplars to generate a first blended exemplar;
aggregating the first blended exemplar with a first noise sample to generate a first noisy exemplar;
generating a first output corresponding to the first class based on processing the first noisy exemplar using a generator neural network; and
outputting the first output.

13. The processor-implemented method of claim 12, wherein aggregating the first blended exemplar with the first noise sample comprises scaling at least one of the first blended exemplar or the first noise sample based on one or more scale values.

14. The processor-implemented method of claim 13, wherein the one or more scale values comprise hyperparameters defined by a requesting entity for the first output.

15. The processor-implemented method of claim 13, wherein the one or more scale values comprise trained parameters having one or more values learned during training of the generator neural network.

16. The processor-implemented method of claim 13, further comprising training the generator neural network and a discriminator neural network based at least in part on the one or more scale values, wherein training the generator neural network and the discriminator neural network comprises at least one of:
(i) training at least one of the generator neural network or the discriminator neural network based on a ratio between first and second scale values of the one or more scale values,
(ii) conditionally freezing training of the discriminator neural network based on comparing the first and second scale values, or
(iii) modulating a loss while training at least one of the generator neural network or the discriminator neural network based on the first and second scale values.

17. The processor-implemented method of claim 12, wherein blending the first set of exemplars comprises at least one of:
(i) combining patches from at least two exemplars of the first set of exemplars to form the first blended exemplar,
(ii) generating a weighted sum of the first set of exemplars to generate the first blended exemplar,
(iii) using one or more orthogonality operations to generate the first blended exemplar based on the first set of exemplars, or
(iv) data processing at least one exemplar of the first set of exemplars to generate the first blended exemplar.

18. The processor-implemented method of claim 12, wherein blending the first set of exemplars comprises processing the first set of exemplars using a blending neural network.

19. The processor-implemented method of claim 18, wherein blending the first set of exemplars further comprises evaluating a prompt indicating one or more blending functions to generate the first blended exemplar using the blending neural network.

20. The processor-implemented method of claim 12, further comprising:
accessing a second set of exemplars corresponding to a second class;
blending the second set of exemplars to generate a second blended exemplar;
combining the first blended exemplar and the second blended exemplar to generate an augmented exemplar;
aggregating the augmented exemplar with a second noise sample to generate a second noisy exemplar; and
generating a second output corresponding to the first and second classes based on processing the second noisy exemplar using the generator neural network.
